(19) United States
(12) Patent Application Publication
(10) Pub. No.: US 2019/0100847 A1
(43) Pub. Date: Apr. 4, 2019

(54) Electroplating Method for Producing Magnetic Conducting Materials

(71) Applicants: Xiao Yu SHEN, Zhejiang (CN); Quan Qiang CHEN, Zhejiang (CN); Feng LI, Zhejiang (CN); Peng Cheng LI, Zhejiang (CN); Zhong Jie ZHANG, Zhejiang (CN); Jian Jiang ZHOU, Zhejiang (CN)

(72) Inventors: Xiao Yu SHEN, Zhejiang (CN); Quan Qiang CHEN, Zhejiang (CN); Feng LI, Zhejiang (CN); Peng Cheng LI, Zhejiang (CN); Zhong Jie ZHANG, Zhejiang (CN); Jian Jiang ZHOU, Zhejiang (CN)

(21) Appl. No.: 15/719,566

(22) Filed: Sep. 29, 2017

(51) Int. Cl. C25D 3/12; C25D 5/04; C25D 5/34; C25D 5/50; C25D 7/06; H01F 41/04

(52) U.S. Cl. CPC C25D 3/12; C25D 5/04; C25D 5/34; B65H 59/06; C25D 7/0607; H01F 41/04; C25D 5/50

(57) ABSTRACT

An electroplating method for producing magnetic conducting materials, such as charging coils used in induction charging of electronic devices, comprising the following steps: constant tension releasing conducting material, such as cooper wire, the conducting material then undergo these process: alkaline washing then clean water washing, degreasing, acidic washing then clean water washing, continuous plating, clean water washing, drying, infrared measuring the diameter and retracting the conducting material. The method allows electroplating preparation of uniform and dense distribution of iron and nickel coating layer on the surface of conducting material, wherein, the thickness of the coating layer is 2˜10 μm. Since the conducting material is non-magnetic, but through the electroplating preparation, the entire charging coil is magnetized to become magnetic material, which when used during induction charging provides the coil with electro resistance that reducing high-frequency skin effect and improving electro induction.

### BACKGROUND OF THE INVENTION

### 1. Field of the Invention

Present invention generally relates to electroplating method, especially to an electroplating method for producing magnetic conducting materials.

### 2. Description of Related Art

Essentially wireless charging uses electromagnetic fields to safely transfer power from a transmitting source to a receiving device for the purposes of charging a battery. And as the name suggests, it does so without the use of a physical connection. Wireless charging is based on the principle of magnetic resonance, or Inductive Power Transfer. This is the process of transferring an electrical current between two objects through the use of coils to induce an electromagnetic field. Because coil needs to be placed inside an electronic device to be charged, there is a strict requirement on the size of the coil. In the present wireless charging coil, pure cooper is used for conductor, under high-frequency electric current, the skin effect causes the actual conducting surface to decrease, at the same time, resistance to electric current increases, as a result, lower the Q value (Q=^{2πf*L}/R) which reduces the converting rate of electric current through electromagnetic induction and has a low efficiency in charging the electronic devices.

### SUMMARY OF THE INVENTION

The present invention provides a solution to the above-identified shortcoming in wireless charging technology by providing an electroplating method for producing magnetic conducting materials that allows for even and dense plating of iron and nickel on conducting material, such cooper wire for making into induction charging coil. After electroplating the cooper wire is magnetized and becomes magnetic material, which when used during induction charging provides the charging coil with electro resistance that reducing high-frequency skin effect and improving electro induction, therefore, increasing the Q value of the coil and significantly improving the electromagnetic to electric current conversion rate of the charging coil.

The present invention provides the following technical solutions: an electroplating method for producing magnetic conducting materials comprising following steps:

(1) Releasing cooper wire on a releasing reel, said cooper wire having a diameter of 0.25±0.01 mm and a direct current resistance of 0.333˜0.392Ω.

(2) Allows the cooper wire goes through a constant tension release device to ensure a constant tension releasing the cooper wire, the constant tension is 1.5±0.5 kgf and the releasing speed is 5-15 m/min.

(3) Alkaline washing then clean water washing: soaking and washing the constant tension released cooper wire in a 7%˜10% of NaOH solution to remove grease and impurities on the surface of the cooper wire, said NaOH solution having a temperature 50° C.˜55° C.; said NaOH solution having a PH value>11; the alkaline washing time is 10˜20 sec, afterward, washing the cooper wire with clean water.

(4) Degreasing process: taking the cooper wire from step (3) and degreasing it with a solution mixed with 7%˜10% of NaOH solution and 5%˜10% of degreasing agent, the temperature of the degreasing process is 50° C.˜55° C. and the degreasing time is 10˜20 sec, the cooper wire then undergo a second degreasing process for better degreasing effect and prepare for the next acidic washing process.

(5) Acidic washing then clean water washing: taking the cooper wire from step (4) and washing it with a 7˜10% diluted sulfuric acid to remove any rust on the surface of the cooper wire, said process also forms oxidizing film on and activates the surface of cooper wire; the washing time in the diluted sulfuric acid is 10˜20 sec, afterward, washing the cooper wire with clean water.

(6) Continuous electroplating: taking the cooper wire from step (5) as positive charge and taking nickel blocks as negative charges, placing said nickel blocks in titanium baskets, run through the constant tension released cooper wire in a plating solution in a plating bath sink to start the electroplating process; said plating solution having a PH value 3˜4; during the plating process the plating solution is controlled at temperature of 55° C.˜65° C. and electric current density of 1˜25 A/dm2; the plating time is 3˜11 min; the plating solution is pumped from a main plating bath sink; when electricity passes through the plating solution, the plating solution reacts with the nickels in the plating bath sink and form nickel deposit layer on the surface of cooper wire, in every one liter of plating solution there is 60˜80 g of nickel ion, 30˜40 g of iron ion, 30˜45 g of boric acid and 10˜20 g of nickel chloride.

(7) Taking the cooper wire from step (6) and washing it with clean water; then, washing it again with a water of temperature of 50° C.˜55° C. and electric conductivity ≤100 μs, this process provides a thorough washing of plating layer on the cooper wire and removing all impurities.

(8) Drying: taking the washed cooper wire and place it in a drying device for dehydrogenation drying, the drying temperature is 110° C.˜220° C. and the drying time is 10˜20 sec.

(9) Infrared diameter measurement: taking the dried cooper wire and using an infrared measuring device to measure its diameter to ensure even plating.

(10) Retracting the conducting material: retracting the cooper wire after infrared diameter measurement, the retracting constant tension is 1.5±0.5 kgf and the line distance is 0.6 mm.

For better result, the main plating solution is provided in the main plating bath sink. The main plating bath sink having a length 700±50 mm, a width 650±50 mm and a height 350±50 mm, the volume of said main plating bath sink is 193 L. The plating bath sink having a length 176 cm, a width 29 cm and a height 20 cm.

For better result, the number of titanium baskets is between 8˜10. The titanium baskets are filled with nickel blocks. The titianium baskets are fixed in the plating bath sink, and the titanium basket having a length 400±50 mm, a width 20±10 mm and a height 80±30 mm.

For better result, the plated cooper wire has a thickness of 2˜10 μm.

The present invention of an electroplating method for producing magnetic conducting materials comprising the use of the following devices:

Releasing reel: for mounting and releasing the cooper wire or other conducting material.

Constant tension release device: provided following the releasing reel and is used to ensure a constant releasing tension of said cooper wire.

Alkaline washing device: provided following the constant tension release device and is used for removing the grease and impurities on the surface of the cooper wire.

First clean water washing device: provided following the alkaline washing device and is used for washing off alkaline solution and impurities on surface of cooper wire.

Degreasing device: provided following the first clean water washing device and is used for further removal of the grease and impurities on the surface of the cooper wire and increasing the degreasing effect for the subsequent acid washing and electroplating process.

Surface activation device: provided following the degreasing device; the surface activation device comprising an acidic washing device and a second clean water washing device, said acidic washing device is used for removing all rust on the surface of cooper wire and formation of oxidizing film to allow the formation of multiple micro clean pores on the surface of cooper wire, which activate the surface of cooper wire; the second water washing device is used for cleaning and removing the acidic solution and impurities on the surface of cooper wire.

Continuous plating device: provided following the surface activation device; said continuous plating device comprising a plating bath sink and a third clean water washing device, said plating bath sink is connected with a main plating bath sink, the plating solution in the main plating bath sink enters into the plating bath sink through an inlet provided in the plating bath sink and the plating solution returns back into the main plating bath sink through an outlet provided in the plating bath sink; the main plating bath sink is further connected with a electrolysis device for providing electrolytic purification treatment of the returned plating solution; when electric current passes through the plating solution, the plating solution reacts with the nickel blocks in the plating bath sink and causes nickel deposition on the surface of cooper wire; the third clean water washing device is used for cleaning the cooper wire and removing plating solution and impurities from the surface of cooper wire.

Hot water washing device: provided following the third clean water washing device and is used for deeper cleansing of the plating layer and removing impurities.

Drying device: provided following the hot water washing device and is used for dehydrogenation drying of the plated cooper wire.

Infrared diameter measuring device: provided following the drying device and is used for infrared measuring the diameter of the dried cooper wire to ensure even plating layer.

Constant tension retracting device: provided following the Infrared diameter measuring device and is used to ensure constant tension retracting of the cooper wire.

Retracting reel: is used for mounting and retracting the cooper wire or other conducting materials.

The benefits of the present invention provides are: the present invention can be used in providing an electroplating magnetic surface layer that is magnetic to conducting material that is non-magnetic for making into charging coil. When the electric current passes through the plated conducting material, the electroplating magnetic surface layer provides electro resistance that reducing high-frequency skin effect and improving electro induction, therefore, increasing the Q value of the coil and significantly improving the electromagnetic to electric current conversion rate of the charging coil. The present invention can be used in various electronic devices, for example, mobile phones, tablet computers and other wireless electronic devices. Through the process of constant tension releasing conducting material, the conducting material then undergo alkaline washing then clean water washing, degreasing, acidic washing then clean water washing, continuous plating, clean water washing, drying, infrared measuring the diameter and retracting the conducting material. The process allows electroplating preparation of uniform and dense distribution of iron and nickel coating layer on the surface of conducting material, wherein, the thickness of the coating layer is 2˜10 μm which provides optimal electro induction.

### BRIEF DESCRIPTION OF DRAWINGS

FIG. 1 is a diagram of the present invention

### DETAILED DESCRIPTION OF THE PRESENT INVENTION

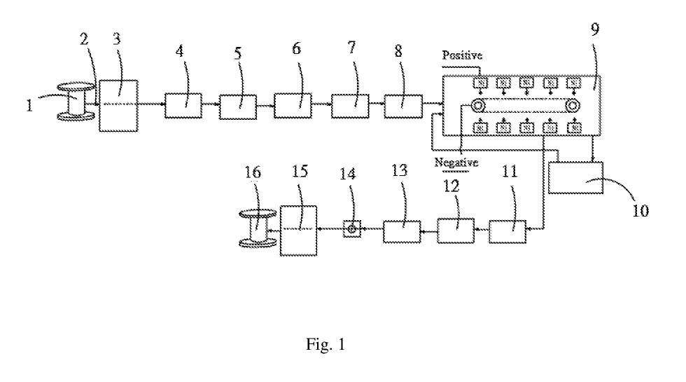

As a preferred embodiment, as shown in FIG. 1, an electroplating method for producing magnetic conducting materials comprising the following steps:
(1) releasing cooper wire on a releasing reel, said cooper wire having a diameter of 0.25 mm and a direct current resistance of 0.37Ω.
(2) allows the cooper wire goes through a constant tension release device to ensure a constant tension releasing the cooper wire, the constant tension is 1.0 kgf and the releasing speed is 10m/min;
(3) alkaline washing then clean water washing: soaking and washing the constant tension released cooper wire in a 8% of NaOH solution to remove grease and impurities on the surface of the cooper wire, said NaOH solution having a temperature 52° C.; said NaOH solution having a PH value 12; the alkaline washing time is 15 sec, afterward, washing the cooper wire with clean water;
(4) degreasing process: taking the cooper wire from step (3) and degreasing it with a solution mixed with 9% of NaOH solution and 8% of degreasing agent, the temperature of the degreasing process is 52° C. and the degreasing time is 15 sec, the cooper wire then undergo a second degreasing process for better degreasing effect and prepare for the next acidic washing process;
(5) acidic washing then clean water washing: taking the cooper wire from step (4) and washing it with a 9% diluted sulfuric acid to remove any rust on the surface of the cooper wire, said process also forms oxidizing film on and activates the surface of cooper wire; the washing time in the diluted sulfuric acid is 15 sec, afterward, washing the cooper wire with clean water;
(6) continuous electroplating: taking the cooper wire from step (5) as positive charge and taking nickel blocks as negative charges, placing said nickel blocks in 8˜10 titanium baskets and then placing the titanium baskets in a plating bath sink, each of the titanium baskets has a length 400 mm, a width 20 mm and a height 80 mm, run through the constant tension released cooper wire in a plating solution in a plating bath sink to start the electroplating process; said plating solution having a PH value 3.6; during the plating process the plating solution is controlled at temperature of 60° C. and electric current density of 15 A/dm2; the plating time is 5 min; the plating solution is pumped from a main plating bath sink; when electricity passes through the plating solution, the plating solution reacts with the nickels in the plating bath sink and form nickel deposit layer on the surface of cooper wire. The plating bath sink has a length of 176 cm, a width 29 cm and a height 20 cm. The plating bath sink is provided in a main plating bath sink. The main plating bath sink has a length of 725 mm, a width 675 mm and a height 394 mm. The main plating bath sink has a volume of 193 L. In every one liter of plating solution there is 70 g of nickel ion, 30 g of iron ion, 35 g of boric acid and 15 g of nickel chloride;
(7) taking the cooper wire from step (6) and washing it with clean water; then, washing it again with a water of temperature of 52° C. and electric conductivity 50 μs, this process provides a thorough washing of plating layer on the cooper wire and removing all impurities;
(8) drying: taking the washed cooper wire and place it in a drying device for dehydrogenation drying, the drying temperature is 170° C. and the drying time is 15 sec;
(9) infrared diameter measurement: taking the dried cooper wire and using an infrared measuring device to measure its diameter to ensure even plating;
(10) retracting the conducting material: retracting the cooper wire after infrared diameter measurement, the retracting constant tension is 1.0 kgf and the line distance is 0.6 mm.

The thickness of the coating layer from the above-described process is 5 μm.

The above-described the electroplating method for producing magnetic conducting materials comprising the use of the following devices:

Releasing reel 1: for mounting and releasing the cooper wire 2 or other conducting material.

Constant tension release device 3: provided following the releasing reel 1 and is used to ensure a constant releasing tension of said cooper wire 2.

Alkaline washing device 4: provided following the constant tension release device 3 and is used for removing the grease and impurities on the surface of the cooper wire 2.

First clean water washing device 5: provided following the alkaline washing device and is used for washing off alkaline solution and impurities on surface of cooper wire 2.

Degreasing device 6: provided following the first clean water washing device 5 and is used for further removal of the grease and impurities on the surface of the cooper wire 2 and increasing the degreasing effect for the subsequent acid washing and electroplating process.

Surface activation device: provided following the degreasing device 6; the surface activation device comprising an acidic washing device 7 and a second clean water washing device 8, said acidic washing device 7 is used for removing all rust on the surface of cooper wire and formation of oxidizing film to allow the formation of multiple micro clean pores on the surface of cooper wire, which activate the surface of cooper wire; the second water washing device 8 is used for cleaning and removing the acidic solution and impurities on the surface of cooper wire 2.

Continuous plating device: provided following the surface activation device; said continuous plating device comprising a plating bath sink 9 and a third clean water washing device 11, said plating bath sink is connected with a main plating bath sink 10, the plating solution in the main plating bath sink 10 enters into the plating bath sink 9 through an inlet provided in the plating bath sink 9 and the plating solution returns back into the main plating bath sink 10 through an outlet provided in the plating bath sink 9; the main plating bath sink 10 is further connected with a electrolysis device for providing electrolytic purification treatment of the returned plating solution; when electric current passes through the plating solution, the plating solution reacts with the nickel blocks in the plating bath sink 9 and causes nickel deposition on the surface of cooper wire; the third clean water washing device 11 is used for cleaning the cooper wire 2 and removing plating solution and impurities from the surface of cooper wire 2.

Hot water washing device 12: provided following the third clean water washing device 11 and is used for deeper cleansing of the plating layer and removing impurities.

Drying device 13: provided following the hot water washing device 12 and is used for dehydrogenation drying of the plated cooper wire 2.

Infrared diameter measuring device 14: provided following the drying device 13 and is used for infrared measuring the diameter of the dried cooper wire 2 to ensure even plating layer.

Constant tension retracting device 15: provided following the Infrared diameter measuring device 14 and is used to ensure constant tension retracting of the cooper wire 2.

Retracting reel 16: is used for mounting and retracting the cooper wire 2 or other conducting materials.

As a second preferred embodiment, the devices used in the second preferred embodiment are the same as the first preferred embodiment, the method for electroplating the conducting material comprising:
(1) releasing cooper wire on a releasing reel, said cooper wire having a diameter of 0.26 mm and a direct current resistance of 0.39Ω.
(2) allows the cooper wire goes through a constant tension release device to ensure a constant tension releasing the cooper wire, the constant tension is 2.0 kgf and the releasing speed is 15 m/min;
(3) alkaline washing then clean water washing: soaking and washing the constant tension released cooper wire in a 10% of NaOH solution to remove grease and impurities on the surface of the cooper wire, said NaOH solution having a temperature 55° C. ; said NaOH solution having a PH value 12; the alkaline washing time is 20 sec, afterward, washing the cooper wire with clean water;
(4) degreasing process: taking the cooper wire from step (3) and degreasing it with a solution mixed with 10% of NaOH solution and 10% of degreasing agent, the temperature of the degreasing process is 55° C. and the degreasing time is 20 sec, the cooper wire then undergo a second degreasing process for better degreasing effect and prepare for the next acidic washing process;
(5) acidic washing then clean water washing: taking the cooper wire from step (4) and washing it with a 10% diluted sulfuric acid to remove any rust on the surface of the cooper wire, said process also forms oxidizing film on and activates the surface of cooper wire; the washing time in the diluted sulfuric acid is 20 sec, afterward, washing the cooper wire with clean water;
(6) continuous electroplating: taking the cooper wire from step (5) as positive charge and taking nickel blocks as negative charges, placing said nickel blocks in 10 titanium baskets and then placing the titanium baskets in a plating bath sink, each of the titanium baskets has a length 400 mm, a width 20 mm and a height 80 mm, run through the constant tension released cooper wire in a plating solution in a plating bath sink to start the electroplating process; said plating solution having a PH value 4; during the plating process the plating solution is controlled at temperature of 65° C. and electric current density of 20 A/dm2; the plating time is 10 min; the plating solution is pumped from a main plating bath sink; when electricity passes through the plating solution, the plating solution reacts with the nickels in the plating bath sink and form nickel deposit layer on the surface of cooper wire. The plating bath sink has a length of 176 cm, a width 29 cm and a height 20 cm. The plating bath sink is provided in a main plating bath sink. The main plating bath sink has a length of 725 mm, a width 675 mm and a height 394 mm. The main plating bath sink has a volume of 193 L. in every one liter of plating solution there is 80 g of nickel ion, 40 g of iron ion, 40 g of boric acid and 15 g of nickel chloride;
(7) taking the cooper wire from step (6) and washing it with clean water; then, washing it again with a water of temperature of 55° C. and electric conductivity 20 μs, this process provides a thorough washing of plating layer on the cooper wire and removing all impurities;
(8) drying: taking the washed cooper wire and place it in a drying device for dehydrogenation drying, the drying temperature is 220° C. and the drying time is 20 sec;
(9) infrared diameter measurement: taking the dried cooper wire and using an infrared measuring device to measure its diameter to ensure even plating;
(10) retracting the conducting material: retracting the cooper wire after infrared diameter measurement, the retracting constant tension is 2.0 kgf and the line distance is 0.6 mm.

The thickness of the coating layer from the above-described process is 10 μm. The thickness of the plating layer is relative to the concentration of the plating solution, the electric current density and plating time. That is, with more concentrated plating solution, electric current density or plating time, the thicker the plating layer is.

Although the present invention has been explained in relation to its preferred embodiment, it is to be understood that many other possible modifications and variations can be made without departing from the spirit and scope of the present invention as hereinafter claimed.

1. An electroplating method for producing magnetic conducting materials comprising the following steps:
(1) releasing cooper wire on a releasing reel, said cooper wire having a diameter of 0.25±0.01 mm and a direct current resistance of 0.333˜0.392Ω;
(2) allows the cooper wire goes through a constant tension release device to ensure a constant tension releasing the cooper wire, the constant tension is 1.5±0.5 kgf and the releasing speed is 5-15 m/min;
(3) alkaline washing then clean water washing: soaking and washing the constant tension released cooper wire in a 7%˜10% of NaOH solution to remove grease and impurities on the surface of the cooper wire, said NaOH solution having a temperature 50° C.˜55° C. ; said NaOH solution having a PH value >11; the alkaline washing time is 10˜20 sec, afterward, washing the cooper wire with clean water;
(4) degreasing process: taking the cooper wire from step (3) and degreasing it with a solution mixed with 7%˜10% of NaOH solution and 5%˜10% of degreasing agent, the temperature of the degreasing process is 50° C.˜55° C. and the degreasing time is 10˜20 sec, the cooper wire then undergo a second degreasing process for better degreasing effect and prepare for the next acidic washing process;
(5) acidic washing then clean water washing: taking the cooper wire from step (4) and washing it with a 7˜10% diluted sulfuric acid to remove any rust on the surface of the cooper wire, said process also forms oxidizing film on and activates the surface of cooper wire; the washing time in the diluted sulfuric acid is 10˜20 sec, afterward, washing the cooper wire with clean water;
(6) continuous electroplating: taking the cooper wire from step (5) as positive charge and taking nickel blocks as negative charges, placing said nickel blocks in titanium baskets, run through the constant tension released cooper wire in a plating solution in a plating bath sink to start the electroplating process; said plating solution having a PH value 3˜4; during the plating process the plating solution is controlled at temperature of 55° C.˜65° C. and electric current density of 1˜25 A/dm2; the plating time is 3˜11 min; the plating solution is pumped from a main plating bath sink; when electricity passes through the plating solution, the plating solution reacts with the nickels in the plating bath sink and form nickel deposit layer on the surface of cooper wire, in every one liter of plating solution there is 60˜80 g of nickel ion, 30˜40 g of iron ion, 30˜45 g of boric acid and 10˜20 g of nickel chloride;
(7) taking the cooper wire from step (6) and washing it with clean water; then, washing it again with a water of temperature of 50° C.˜55° C. and electric conductivity ≤100 μs, this process provides a thorough washing of plating layer on the cooper wire and removing all impurities;
(8) drying: taking the washed cooper wire and place it in a drying device for dehydrogenation drying, the drying temperature is 110° C.˜220° C. and the drying time is 10˜20 sec;
(9) infrared diameter measurement: taking the dried cooper wire and using an infrared measuring device to measure its diameter to ensure even plating;
(10) retracting the conducting material: retracting the cooper wire after infrared diameter measurement, the retracting constant tension is 1.5±0.5 kgf and the line distance is 0.6 mm.

2. The electroplating method for producing magnetic conducting materials as claimed in claim 1, wherein, said plating solution is provided in the main plating bath sink, said main plating bath sink having a length 700±50 mm, a width 650±50 mm and a height 350±50 mm, the volume of said main plating bath sink is 193 L; wherein, said plating bath sink having a length 176 cm, a width 29 cm and a height 20 cm.

3. The electroplating method for producing magnetic conducting materials as claimed in claim 1, wherein, the number of said titanium baskets is between 8˜10, the titanium baskets are filled with nickel blocks, said titianium baskets are fixed in the plating bath sink, said titanium basket having a length 400±50 mm, a width 20±10 mm and a height 80±30 mm.

3. The electroplating method for producing magnetic conducting materials as claimed in claim 1, wherein, it is characterized that the plated cooper wire having a thickness of 2˜10 μm.

4. The electroplating method for producing magnetic conducting materials as claimed in claim 1˜4, wherein, the method comprising the use of the following devices:
releasing reel: for mounting and releasing the cooper wire or other conducting material;
constant tension release device: provided following the releasing reel and is used to ensure a constant releasing tension of said cooper wire;
alkaline washing device: provided following the constant tension release device and is used for removing the grease and impurities on the surface of the cooper wire;
first clean water washing device: provided following the alkaline washing device and is used for washing off alkaline solution and impurities on surface of cooper wire;
degreasing device: provided following the first clean water washing device and is used for further removal of the grease and impurities on the surface of the cooper wire and increasing the degreasing effect for the subsequent acid washing and electroplating process;
surface activation device: provided following the degreasing device; the surface activation device comprising an acidic washing device and a second clean water washing device, said acidic washing device is used for removing all rust on the surface of cooper wire and formation of oxidizing film to allow the formation of multiple micro clean pores on the surface of cooper wire, which activate the surface of cooper wire; the second water washing device is used for cleaning and removing the acidic solution and impurities on the surface of cooper wire;
continuous plating device: provided following the surface activation device; said continuous plating device comprising a plating bath sink and a third clean water washing device, said plating bath sink is connected with a main plating bath sink, the plating solution in the main plating bath sink enters into the plating bath sink through an inlet provided in the plating bath sink and the plating solution returns back into the main plating bath sink through an outlet provided in the plating bath sink; the main plating bath sink is further connected with a electrolysis device for providing electrolytic purification treatment of the returned plating solution; when electric current passes through the plating solution, the plating solution reacts with the nickel blocks in the plating bath sink and causes nickel deposition on the surface of cooper wire; the third clean water washing device is used for cleaning the cooper wire and removing plating solution and impurities from the surface of cooper wire;
hot water washing device: provided following the third clean water washing device and is used for deeper cleansing of the plating layer and removing impurities ;
drying device: provided following the hot water washing device and is used for dehydrogenation drying of the plated cooper wire;
infrared diameter measuring device: provided following the drying device and is used for infrared measuring the diameter of the dried cooper wire to ensure even plating layer;
constant tension retracting device: provided following the Infrared diameter measuring device and is used to ensure constant tension retracting of the cooper wire; and
retracting reel: is used for mounting and retracting the cooper wire or other conducting materials.
